(19) United States
(12) Patent Application Publication
(10) Pub. No.: US 2012/0323821 A1
(43) Pub. Date: Dec. 20, 2012

(54) METHODS FOR BILLING FOR DATA STORAGE IN A TIERED DATA STORAGE SYSTEM

(75) Inventors: Igor Crk, Tucson, AZ (US); Gary I. Dickenson, Tucson, AZ (US); Paul A. Jennas, II, Tucson, AZ (US); Larry Juarez, Tucson, AZ (US); Jason L. Peipelman, Vail, AZ (US); Todd C. Sorenson, Tucson, AZ (US); David V. Valverde, Tucson, AZ (US)

(73) Assignee: INTERNATIONAL BUSINESS MACHINES CORPORATION, Armonk, NY (US)

(21) Appl. No.: 13/161,448

(22) Filed: Jun. 15, 2011

(51) Int. Cl. G06F 17/00

(52) U.S. Cl. 705/400

(57) ABSTRACT

In one embodiment, a method for determining pricing for data storage includes receiving from a data provider a request indicating an amount of data storage space in at least one of one or more tiers of data storage, receiving data from the data provider to store in the at least one of the one or more tiers of data storage, storing the data provider's data in the at least one of the one or more tiers of data storage, and calculating a base price for storage of the data provider's data. In another embodiment, a tiered storage system includes a processor, a memory, logic adapted for determining an amount of a data provider's data in each of at least two tiers of data storage, and logic adapted for calculating a price for storage of the data provider's data.

### BACKGROUND

The present invention relates to tiered data storage systems, and more particularly, to billing practices for storing data on tiered data storage systems.

A data storage system, such as a cloud storage system which may be a tiered data storage system, is typically maintained by an entity (a storage provider) which is not utilizing the system for storing its own data. Instead, the storage provider charges customers (data providers) to store their data on the storage system. The storage provider then charges the data provider to store the data provider's data.

When multiple data providers' data is stored to a data storage system, each data provider may be utilizing a different amount of storage space on the data storage system. Accordingly, each data provider is typically charged according to its usage of the data storage space on the data storage system.

### BRIEF SUMMARY

In one embodiment, a method for determining pricing for data storage includes receiving from a data provider a request indicating an amount of data storage space in at least one of one or more tiers of data storage, receiving data from the data provider to store in the at least one of the one or more tiers of data storage, storing the data provider's data in the at least one of the one or more tiers of data storage, and calculating a base price for storage of the data provider's data, wherein the base price is based at least partially on which of the one or more tiers of data storage that the data provider's data is stored in.

In another embodiment, tiered storage system includes a processor, a memory, logic adapted for determining an amount of a data provider's data in each of at least two tiers of data storage, and logic adapted for calculating a price for storage of the data provider's data, wherein the price is based at least partially on amounts of the data provider's data stored in each of the tiers, and the price is further based at least partially on one or more transfers of at least a portion of the data provider's data between the tiers.

In yet another embodiment, a computer program product for determining pricing for data storage includes a computer readable storage medium having computer readable program code embodied therewith and configured to receive from a data provider a request indicating an amount of data storage space in at least one of one or more tiers of data storage, computer readable program code embodied configured to receive data from the data provider to store in the at least one of the one or more tiers of data storage, computer readable program code embodied configured to store the data provider's data in the at least one of the one or more tiers of data storage, and computer readable program code embodied configured to calculate a base price for storage of the data provider's data and the base price is based at least partially on which of the one or more tiers of data storage that the data provider's data is stored in.

Other aspects and embodiments of the present invention will become apparent from the following detailed description, which, when taken in conjunction with the drawings, illustrates by way of example the principles of the invention.

### BRIEF DESCRIPTION OF THE SEVERAL VIEWS OF THE DRAWINGS

FIG. 1 depicts a cloud computing node, according to one embodiment.

FIG. 2 depicts a cloud computing environment, according to one embodiment.

FIG. 3 depicts abstraction model layers, according to one embodiment.

FIG. 4 illustrates a simplified schematic of a data storage system according to one embodiment.

FIG. 5 illustrates a flowchart of a method for determining pricing for data storage, according to one embodiment.

FIG. 6 is a schematic diagram of a tiered data storage system, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an,” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of methods and systems for charging customers (data providers) according to a more comprehensive calculation of their usage of storage space on the data storage system than is currently performed.

In one general embodiment, a method for determining pricing for data storage includes receiving from a data provider a request indicating an amount of data storage space in at least one of one or more tiers of data storage, receiving data from the data provider to store in the at least one of the one or more tiers of data storage, storing the data provider's data in the at least one of the one or more tiers of data storage, and calculating a base price for storage of the data provider's data, wherein the base price is based at least partially on which of the one or more tiers of data storage that the data provider's data is stored in.

In another general embodiment, a tiered storage system includes a processor, a memory, logic adapted for determining an amount of a data provider's data in each of at least two tiers of data storage, and logic adapted for calculating a price for storage of the data provider's data, wherein the price is based at least partially on amounts of the data provider's data stored in each of the tiers, and the price is further based at least partially on one or more transfers of at least a portion of the data provider's data between the tiers.

In still another general embodiment, a computer program product for determining pricing for data storage includes a computer readable storage medium having computer readable program code embodied therewith and configured to receive from a data provider a request indicating an amount of data storage space in at least one of one or more tiers of data storage, computer readable program code embodied configured to receive data from the data provider to store in the at least one of the one or more tiers of data storage, computer readable program code embodied configured to store the data provider's data in the at least one of the one or more tiers of data storage, and computer readable program code embodied configured to calculate a base price for storage of the data provider's data, and the base price is based at least partially on which of the one or more tiers of data storage that the data provider's data is stored in.

A data provider who has data stored on a data storage system maintained by a storage provider may be charged based on any number of factors. These factors may include the amount of data being stored, the data provider's expected access level to the stored data, the cost of the storage media on which the data provider's data is stored, etc. In a tiered data storage system, the storage media that the data is stored on may cost the storage provider more or less to maintain and manage based on the type of storage media. Accordingly, the storage provider may charge the data provider more or less in proportion to the cost of the type of storage media being used to store the data provider's data in order to effectively recover costs associated with storing the data provider's data and to be competitive in the marketplace, according to one embodiment.

In addition, when a tiered storage architecture is used, it is most likely used in conjunction with a technology for managing data throughout the tiers, such as IBM Easy Tier, where data is automatically moved to the most appropriate tier based on data provider I/O data patterns.

It is to be understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, services, etc.) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

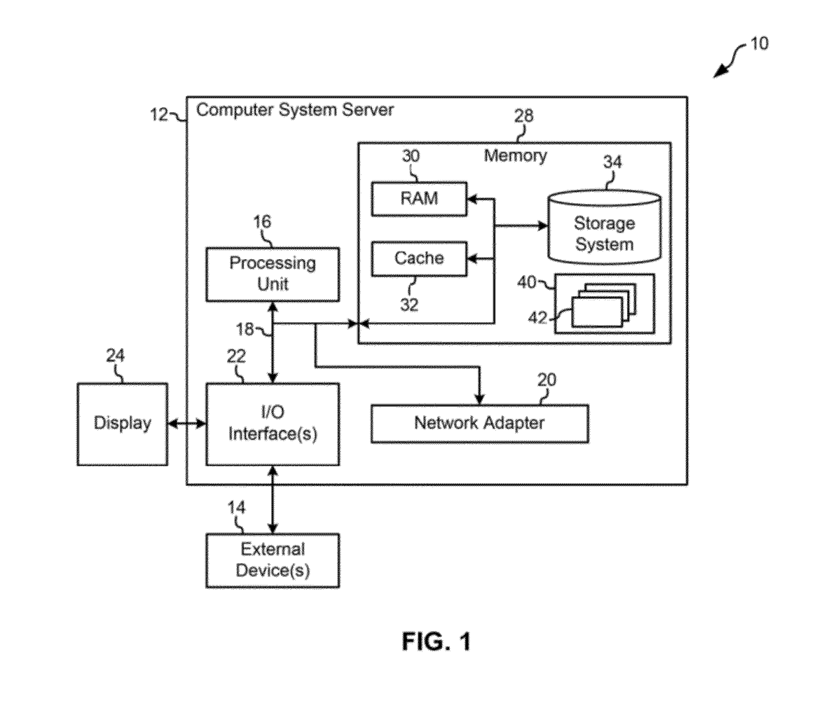

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM. DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

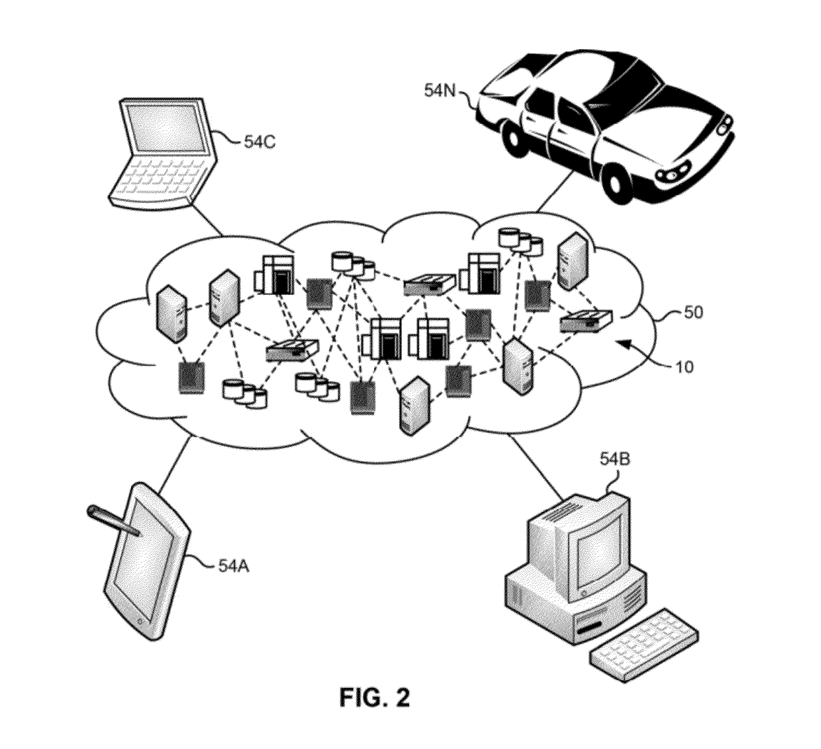

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer MC, and/or automobile computer system MN may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

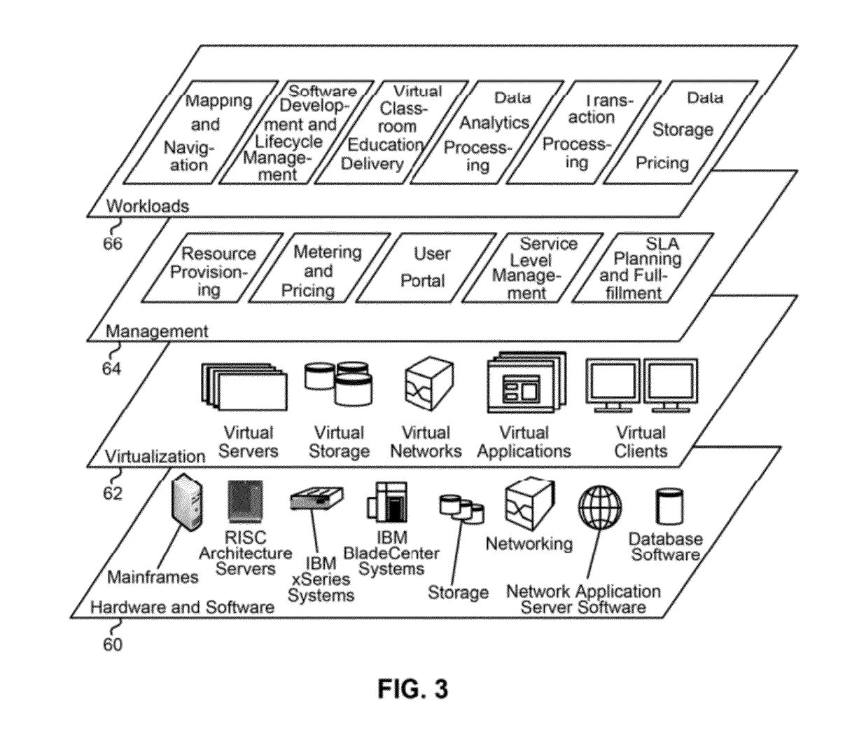

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; charging data providers according to storage tier and transfers between storage tiers; etc.

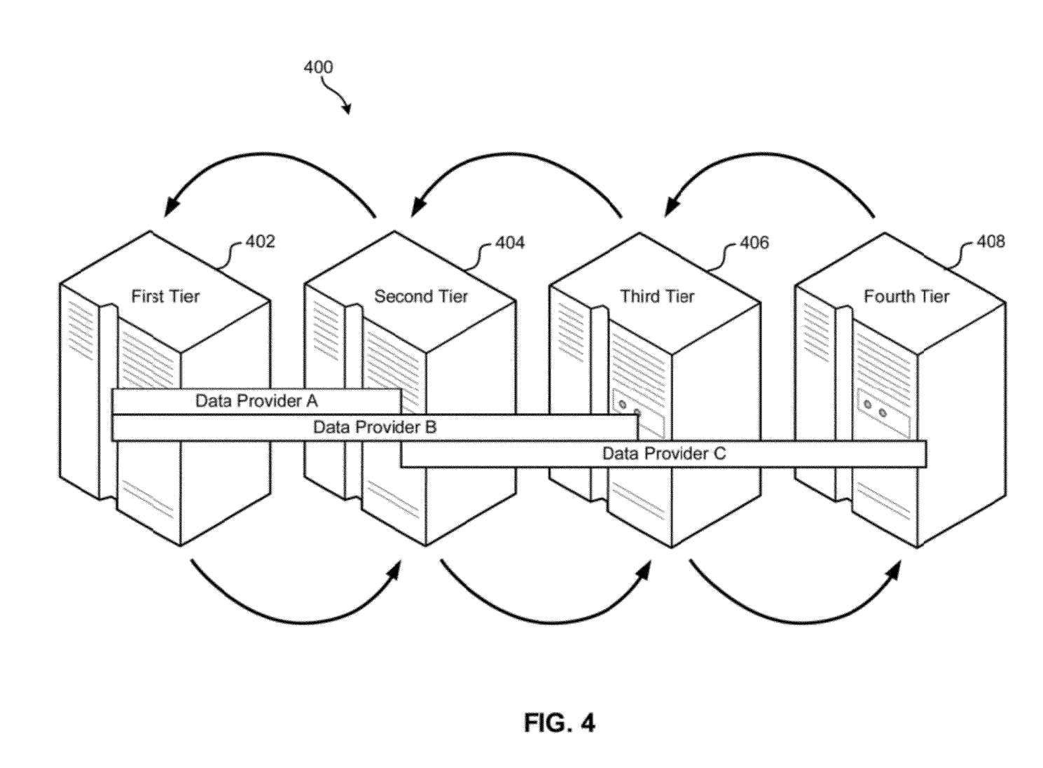

Now referring to FIG. 4, a simplified schematic diagram of a storage system 400 is shown according to one embodiment. In one embodiment, a data provider may be charged based on an amount of storage needed per storage tier in the data storage system 400. For example, Data Provider A may be charged for utilizing storage space in the first storage tier 402 and the second storage tier 404. In another example, Data Provider C may be charged for storage space in the second storage tier 404, the third storage tier 406, and the fourth storage tier 408. The highest performing storage tier, such as the first storage tier 402, may cost the most, the lowest performance tier, such as the fourth storage tier 408, may cost the least, and tiers in between, such as the second storage tier 406 and the third storage tier 408, may cost a price in between the highest and the least.

In addition, each data provider may be charged for a number of data transfers, as indicated by the arrows, between the storage tiers. Data providers with I/O data patterns that use a high number of data transfers between the storage tiers may therefore be charged more than data providers having I/O data patterns that do not use a high number of data transfers.

In another embodiment, each data provider may determine an amount of data storage space in each storage tier of the data storage system that the data provider deems will be sufficient for its storage needs. Each storage tier may be described as having certain system characteristics, for instance: a number of maximum I/O parities (IOPs), a maximum bandwidth, a maximum I/O latency, etc. Furthermore, the data provider may be charged for storage of its data based on how much storage space was reserved/used per storage tier (using a rate, such as terabytes of storage per tier per month, or any other rate as would be understood by one of skill in the art upon reading the present descriptions).

With continued reference to FIG. 4, as described previously, the arrows represent data transfers between the first storage tier 402, the second storage tier 404, the third storage tier 406, and the fourth storage tier 408. A decision as to which data is transferred and the transfers themselves may be performed using existing technology, such as IBM Easy Tier Technology, among others.

The amount of transfers between tiers needed by a data provider may be related to each data provider's I/O patterns and tendencies. For example, a first data provider may have a set of data that is most often “hot,” meaning that it is accessed by the first data provider at a rate such that it is not moved down in the tiers to a lower tier. Therefore, once this set of data is placed to the highest data tier, such as a tier comprising SSD storage, that set of data stays in that tier for a very long time and very few transfers are made between the tiers in connection with this set of data. However, a second data provider may have a set of data that gets hot for a few hours, days, weeks, etc., and then that set of data grows “cold,” meaning that it is not accessed often, and the set of data should be moved down the tiers, e.g., it should be transferred to a lower tier, such as a tier comprising magnetic tape storage. Then, when the set of data gets hot again, the set of data should be transferred up to the highest tier again. In this case, the second data provider is having vastly more transfers of data between tiers in the data storage system, which uses system resources to perform. Thus, the second customer should be charged according to the amount of transfers it requires for managing its data.

Therefore, according to one embodiment, an additional price in addition to the base price may be charged, with the additional price being based on an amount of data moved between tiers and/or a number of transfers of data between tiers. In one approach, the additional price may be calculated as follows. First, A number of transfers and/or a amount of data being transferred between storage tiers per month is included in the base price, and an additional price is not added to the base price for data providers who fall into this category. The next B number of transfers and/or h amount of data being transferred between storage tiers per month may be calculated in the additional price at a rate of X $/transfer and/or x $/data transferred. The next C number of transfers and/or c amount of data being transferred between storage tiers per month may be calculated in the additional price at a rate of Y $/transfer and/or y $/data transferred, wherein Y≧X and y>≧x. The next D number of transfers and/or d amount of data being transferred between storage tiers per month may be calculated in the additional price at a rate of Z $/transfer and/or z $/data transferred, wherein z≧Y and z≧y. This approach may be repeated for as many pricing levels as desired by the storage provider to compensate for the actual cost of data storage for the data providers being serviced by the data provider, and/or to encourage data providers to provide data/request storage tiers in a beneficial way.

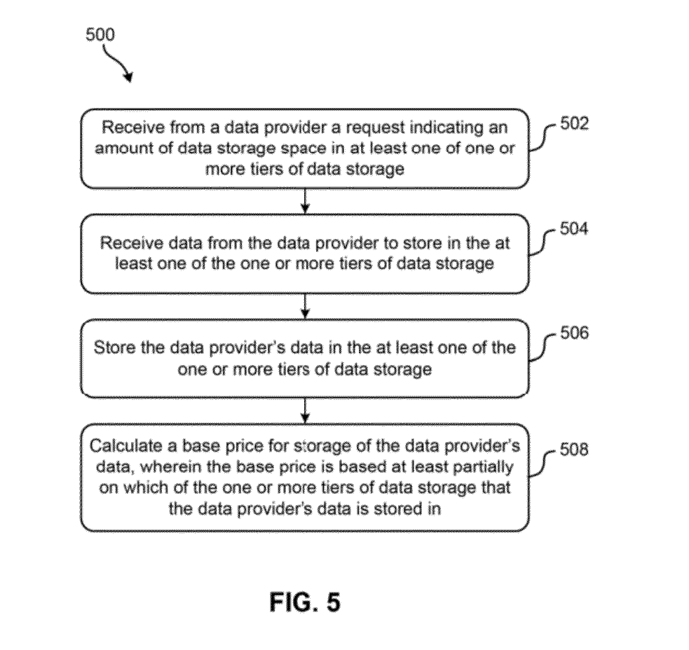

Now referring to FIG. 5, a method 500 for determining pricing for data storage is shown according to one embodiment. The method 500 may be carried out in any desired environment, including those shown in FIGS. 1-4, among others.

In operation 502, a request is received from a data provider indicating an amount of data storage space in at least one of one or more tiers of data storage.

In operation 504, data to store in the at least one of the one or more tiers of data storage is received from the data provider.

In operation 506, the data provider's data is stored in the at least one of the one or more tiers of data storage.

In operation 508, a base price for storage of the data provider's data is calculated. The base price is based at least partially on which of the one or more tiers of data storage that the data provider's data is stored in.

According to some embodiments, an additional price may be calculated based at least partially on one or more transfers of at least a portion of the data provider's data between at least two tiers of the one or more tiers of data storage.

In a further embodiment, the data provider may be charged periodically an amount equal to the base price plus the additional price. If the additional price is zero, then the data provider is only charged the base price.

In one approach, the additional price may be based on at least one of: a number of transfers, an amount of data transferred, and a combination of the number of transfers and the amount of data transferred for the data provider's data. In a further approach, each transfer occurring after a threshold has been reached may increase the additional price more than a transfer which occurs before the threshold is reached. The threshold may be based at least partially on at least one of: the number of transfers, the amount of data transferred, the combination of transfers and data transferred for the data provider's data.

In another approach, the additional price calculation may not include at least one of: a predetermined number of transfers, a predetermined amount of data transferred, and a predetermined combination of transfers and data transferred for the data provider's data. For example, the base price may include a certain number of data transfers, an amount of data transfer, and/or a combination of data transfers and data transferred for which an additional price is not charged to the data provider. However, after the predetermined amount has been reached, the data provider may then be charged the additional price normally.

In one approach, the additional price calculation may comprise scaling the additional price across pricing tiers for at least one of: a number of transfers, an amount of data transferred, and a combination of transfers and data transferred. The pricing tiers may be more expensive as the number of transfers increases, the amount of data transferred increases, or the combination of transfers and data transferred increases, in a preferred approach.

According to one embodiment, the one or more tiers of data storage may comprise at least one of: a solid state storage device, a hard disk drive and a magnetic disk medium, an optical disk drive and an optical disk medium, and a magnetic tape drive and a magnetic tape medium.

Also, in some approaches, the one or more tiers of data storage may comprise: a first storage tier comprising higher availability storage media and a second storage tier comprising lower availability storage media. Storing a portion of the data provider's data on the first storage tier may increase the base price more than storing the same portion of the data provider's data on the second storage tier.

In another approach, the one or more tiers of data storage may comprise: a first storage tier comprising first storage media that is more expensive and a second storage tier comprising storage media that is less expensive. Expense may be calculated based on a purchase price, a maintenance cost, a servicing cost, a combination of these, etc. In this approach, storing a portion of the data provider's data on the first storage tier increases the base price more than storing the same portion of the data provider's data on the second storage tier.

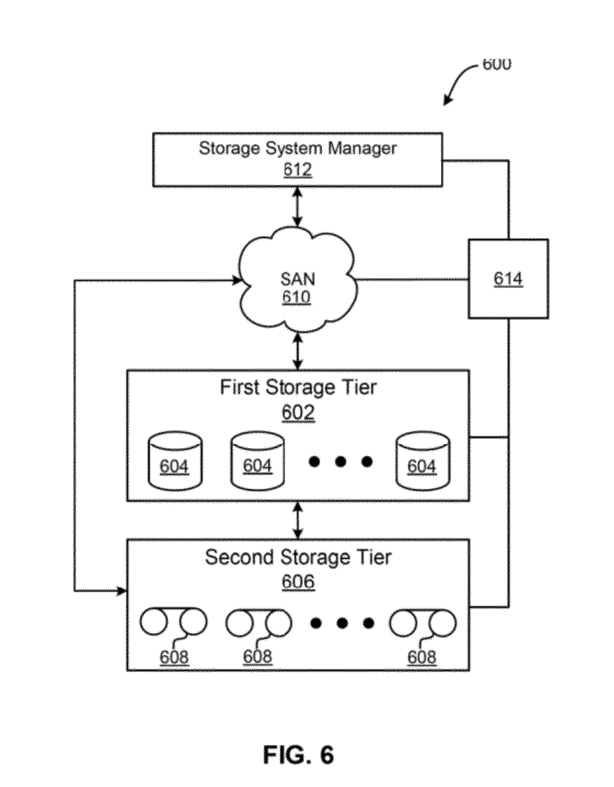

Next, as shown in FIG. 6, a tiered data storage system 600 is described, according to one embodiment. Note that some of the elements shown in FIG. 6 may be implemented as hardware and/or software, according to various embodiments. The storage system 600 may include a processor 614 and a memory (which may be represented as tiers of data storage 602, 606, etc.). The system 600 may also include a storage system manager 612 for communicating with a plurality of storage media on at least two tiers of data storage: a first storage tier 602 and a second storage tier 606. Of course, more storage tiers may be included in the tiered storage system 600 according to various more embodiments, as would be apparent to one of skill in the art.

The first storage tier 602 preferably may include SSDs and/or random access media 604, such as hard disks in hard disk drives. The second storage tier 606 may preferably include sequential access media 608, such as magnetic tape in tape drives. The storage system manager 612 may communicate with the storage media 604, 608 on the first and second storage tiers 602, 606 through a network 610, such as a storage area network, as shown in FIG. 6. Of course, any arrangement of a storage system may be used, as would be apparent to those of skill in the art upon reading the present descriptions.

In one embodiment, the at least two tiers of data storage may comprise at least one of: a solid state storage device, a hard disk drive and a magnetic disk medium, an optical disk drive and an optical disk medium, and a magnetic tape drive and a magnetic tape medium.

Further, in some embodiments, the memory may include at least two tiers of data storage, comprising: a first storage tier 602 comprising higher availability storage media, and a second storage tier 606 comprising lower availability storage media, wherein storing a portion of the data provider's data on the first storage tier 602 increases the base price more than storing the same portion of the data provider's data on the second storage tier 606.

In more approaches, the memory may comprise at least two tiers of data storage, comprising: a first storage tier 602 comprising first storage media 604 that is more expensive, and a second storage tier 606 comprising storage media 608 that is less expensive than the first storage media 604, wherein storing a portion of the data provider's data on the first storage tier 602 increases the base price more than storing the same portion of the data provider's data on the second storage tier 606.

The storage system 600 also includes logic adapted for receiving from a data provider a request indicating an amount of data storage space in at least one of the two tiers of data storage, and logic adapted for receiving data from the data provider to store in the at least one of the at least two tiers of data storage. In another approach, the system 600 may include logic adapted for determining an amount of a data provider's data in each of at least two tiers of data storage. In some embodiments, the system 600 may also include logic adapted for storing the data provider's data in the at least one of the at least two tiers of data storage.

In preferred embodiments, the system 600 includes logic adapted for calculating a price for storage of the data provider's data, wherein the price is based at least partially on amounts of the data provider's data stored in each of the tiers. The price may further be based at least partially on one or more transfers of at least a portion of the data provider's data between the tiers.

In some approaches, the price may also be based at least partially on one or more transfers of at least a portion of the data provider's data between the tiers of data storage. In another approach, logic adapted for charging the data provider periodically an amount equal to the price may also be included.

In some embodiments, the price may further be based on at least one of a number of transfers, an amount of data transferred, and a combination of the number of transfers and the amount of data transferred of the data provider's data.

In another embodiment, each transfer occurring after a threshold has been reached may increase the price more than a transfer which occurs before the threshold is reached. The threshold may be based at least partially on at least one of the number of transfers, the amount of data transferred, and the combination of the number of transfers and the amount of data transferred of the data provider's data.

In one embodiment, the logic adapted for calculating the price may be determined such that it does not include at least one of: a predetermined number of transfers, a predetermined amount of data transferred, and a predetermined combination of transfers and data transferred for the data provider's data.

In one approach, the logic adapted for calculating the price may comprise: logic adapted for scaling the price across pricing tiers for each of: a number of transfers, an amount of data transferred, or a combination of transfers and data transferred for the data provider's data, and the pricing tiers are more expensive as the number of transfers increases, the amount of data transferred increases, or the combination of transfers and data transferred increases.

In another embodiment, a computer program product for determining pricing for data storage may comprise a computer readable storage medium having computer readable program code embodied therewith. The computer readable program code may comprise computer readable program code configured to: receive from a data provider a request indicating an amount of data storage space in at least one of one or more tiers of data storage; receive data from the data provider to store in the at least one of the one or more tiers of data storage; store the data provider's data in the at least one of the one or more tiers of data storage; and calculate a base price for storage of the data provider's data, wherein the base price is based at least partially on which of the one or more tiers of data storage that the data provider's data is stored in.

In one approach, the computer program product may further comprise computer readable program code configured to calculate an additional price based at least partially on one or more transfers of at least a portion of the data provider's data between at least two tiers of the one or more tiers of data storage.

In another embodiment, the additional price may be based on at least one of a number of transfers, an amount of data transferred, and a combination of the number of transfers and the amount of data transferred.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” a “circuit,” a “module,” or a “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

1. A method for determining pricing for data storage, the method comprising:
receiving from a data provider a request indicating an amount of data storage space in at least one of one or more tiers of data storage;
receiving data from the data provider to store in the at least one of the one or more tiers of data storage;
storing the data provider's data in the at least one of the one or more tiers of data storage; and
calculating, using a processor implemented in hardware:
a base price for storage of the data provider's data, wherein the base price is based at least partially on which of the one or more tiers of data storage that the data provider's data is stored in, and
an additional price based at least partially on one or more transfers of at least a portion of the data provider's data between at least two tiers of the one or more tiers of data storage, and
wherein each transfer occurring after a threshold has been reached increases the additional price more than a transfer which occurs before the threshold is reached.

2. The method as recited in claim 1, further comprising charging the data provider periodically an amount equal to the base price plus the additional price,
wherein the additional price is based on at least one of: a number of transfers, an amount of data transferred, and a combination of the number of transfers and the amount of data transferred,
wherein the threshold is based at least partially on at least one of: the number of transfers, the amount of data transferred, the combination of transfers and data transferred,
wherein the additional price calculation does not include at least one of: a predetermined number of transfers, a predetermined amount of data transferred, and a predetermined combination of transfers and data transferred,
wherein the additional price calculation comprises scaling the additional price across pricing tiers for at least one of: a number of transfers, an amount of data transferred, and a combination of transfers and data transferred, and
wherein the pricing tiers are more expensive as the number of transfers increases, the amount of data transferred increases, or the combination of transfers and data transferred increases.

3. The method as recited in claim 1, further comprising charging the data provider periodically an amount equal to the base price plus the additional price.

4. The method as recited in claim 1, wherein the additional price is based on at least one of: a number of transfers, an amount of data transferred, and a combination of the number of transfers and the amount of data transferred.

5. The method as recited in claim 4, wherein the threshold is based at least partially on at least one of: the number of transfers, the amount of data transferred, the combination of transfers and data transferred.

6. The method as recited in claim 4, wherein the additional price calculation does not include at least one of: a predetermined number of transfers, a predetermined amount of data transferred, and a predetermined combination of transfers and data transferred.

7. The method as recited in claim 6, wherein the additional price calculation comprises:
scaling the additional price across pricing tiers for at least one of: a number of transfers, an amount of data transferred, and a combination of transfers and data transferred,
wherein the pricing tiers are more expensive as the number of transfers increases, the amount of data transferred increases, or the combination of transfers and data transferred increases.

8. The method as recited in claim 1, wherein the one or more tiers of data storage comprise at least one of: a solid state storage device, a hard disk drive and a magnetic disk medium, an optical disk drive and an optical disk medium, and a magnetic tape drive and a magnetic tape medium.

9. A tiered storage system, comprising:
a processor adapted for executing logic;
a memory adapted for storing data that is accessible to the processor;
logic adapted for determining an amount of a data provider's data in each of at least two tiers of data storage; and
logic adapted for calculating a price for storage of the data provider's data, wherein the price is based at least partially on amounts of the data provider's data stored in each of the tiers, wherein the price is further based at least partially on one or more transfers of at least a portion of the data provider's data between the tiers,
wherein each transfer occurring after a threshold has been reached increases the price more than a transfer which occurs before the threshold is reached.

10. The system as recited in claim 9, further comprising logic adapted for charging the data provider periodically an amount equal to the price,
wherein the additional price is based on at least one of: a number of transfers, an amount of data transferred, and a combination of the number of transfers and the amount of data transferred,
wherein the threshold is based at least partially on at least one of: the number of transfers, the amount of data transferred, the combination of transfers and data transferred,
wherein the additional price calculation does not include at least one of: a predetermined number of transfers, a predetermined amount of data transferred, and a predetermined combination of transfers and data transferred,
wherein the additional price calculation comprises scaling the additional price across pricing tiers for at least one of: a number of transfers, an amount of data transferred, and a combination of transfers and data transferred, and
wherein the pricing tiers are more expensive as the number of transfers increases, the amount of data transferred increases, or the combination of transfers and data transferred increases.

11. The system as recited in claim 9, wherein the price is further based on at least one of: a number of transfers, an amount of data transferred, and a combination of the number of transfers and the amount of data transferred.

12. The system as recited in claim 11, wherein the threshold is based at least partially on at least one of: the number of transfers, the amount of data transferred, and the combination of the number of transfers and the amount of data transferred.

13. The system as recited in claim 9, wherein the logic adapted for calculating the price does not include at least one of: a predetermined number of transfers, a predetermined amount of data transferred, and a predetermined combination of transfers and data transferred.

14. The system as recited in claim 13, wherein the logic adapted for calculating the price further comprises:
logic adapted for scaling the price across pricing tiers for each of: a number of transfers, an amount of data transferred, or a combination of the number of transfers and the amount of data transferred,
wherein the pricing tiers are more expensive as the number of transfers increases, the amount of data transferred increases, or the combination of the number of transfers and the amount of data transferred increases.

15. The system as recited in claim 9, wherein the memory comprises at least one of: a solid state storage device, a hard disk drive and a magnetic disk medium, an optical disk drive and an optical disk medium, and a magnetic tape drive and a magnetic tape medium.

16. The system as recited in claim 9, wherein the memory comprises at least two tiers of data storage, comprising:
a first storage tier comprising higher availability storage media; and
a second storage tier comprising lower availability storage media,
wherein storing a portion of the data provider's data on the first storage tier increases the price more than storing the portion of the data provider's data on the second storage tier.

17. The system as recited in claim 9, wherein the memory comprises at least two tiers of data storage, comprising:
a first storage tier comprising first storage media that is more expensive; and
a second storage tier comprising storage media that is less expensive than the first storage media,
wherein storing a portion of the data provider's data on the first storage tier increases the price more than storing the portion of the data provider's data on the second storage tier.

18. A computer program product for determining pricing for data storage, the computer program product comprising a computer readable storage medium having computer readable program code embodied therewith, the computer readable program code comprising:
computer readable program code configured to receive from a data provider a request indicating an amount of data storage space in at least one of one or more tiers of data storage;
computer readable program code configured to receive data from the data provider to store in the at least one of the one or more tiers of data storage;
computer readable program code configured to store the data provider's data in the at least one of the one or more tiers of data storage;
computer readable program code configured to calculate a base price for storage of the data provider's data, wherein the base price is based at least partially on which of the one or more tiers of data storage that the data provider's data is stored in; and
computer readable program code configured to calculate an additional price based at least partially on one or more transfers of at least a portion of the data provider's data between at least two tiers of the one or more tiers of data storage,
wherein each transfer occurring after a threshold has been reached increases the additional price more than a transfer which occurs before the threshold is reached.

19. The computer program product as recited in claim 18, wherein the threshold is based at least partially on at least one of: the number of transfers, the amount of data transferred, and the combination of the number of transfers and the amount of data transferred.

20. The computer program product as recited in claim 19, further comprising computer readable program code configured to charge the data provider periodically an amount equal to the base price plus the additional price,
wherein the additional price is based on at least one of: a number of transfers, an amount of data transferred, and a combination of the number of transfers and the amount of data transferred,
wherein the threshold is based at least partially on at least one of: the number of transfers, the amount of data transferred, the combination of transfers and data transferred,
wherein the additional price calculation does not include at least one of: a predetermined number of transfers, a predetermined amount of data transferred, and a predetermined combination of transfers and data transferred,
wherein the additional price calculation comprises scaling the additional price across pricing tiers for at least one of: a number of transfers, an amount of data transferred, and a combination of transfers and data transferred, and
wherein the pricing tiers are more expensive as the number of transfers increases, the amount of data transferred increases, or the combination of transfers and data transferred increases.
